(19) United States
(12) Patent Application Publication
(10) Pub. No.: US 2025/0086311 A1
(43) Pub. Date: Mar. 13, 2025

(54) DATA PROCESSING ESTIMATING METHOD FOR PRIVACY PROTECTION AND SYSTEM FOR PERFORMING THE SAME

(71) Applicant: Korea Advanced Institute of Science and Technology, Daejeon (KR)

(72) Inventors: Si-Hyeon LEE, Daejeon (KR); Hyunyoung PARK, Daejeon (KR); Seung-Hyun NAM, Daejeon (KR)

(73) Assignee: Korea Advanced Institute of Science and Technology, Daejeon (KR)

(21) Appl. No.: 18/649,182

(22) Filed: Apr. 29, 2024

(30) Foreign Application Priority Data
Sep. 8, 2023 (KR) 10-2023-0119380

(51) Int. Cl. G06F 21/62

(52) U.S. Cl. CPC G06F 21/6245

(57) ABSTRACT

A data processing estimating method for privacy protection using a statistical estimation block design and a system for performing the method is disclosed. A data processing estimating system for privacy protection includes a block design unit for designing block designs for statistical estimation shared between data providers and data users; a modification data generating unit for generating modification data in a random manner along a conditional distribution for the original data of the above statistical estimation block design; and a data distribution estimating unit for estimating the distribution of the original data using an estimation function based on the statistical estimation block design. Accordingly, data processing techniques and estimation functions are provided by utilizing statistical estimation block designs shared between data providers and data users, thereby preventing leakages of sensitive personal information such as personal photos, purchase records, and locations included in the collected data, it is possible to increase statistical accuracy and communication efficiency while satisfying the goal of privacy protection by preventing leakage of sensitive personal information.

### CROSS-REFERENCE TO RELATED APPLICATIONS

This application claims priority under 35 U.S.C. § 119 to Korean Patent Application No. 10-2023-0119380, filed on Sep. 8, 2023 in the Korean Intellectual Property Office (KIPO), the contents of which are herein incorporated by reference in their entirety.

### BACKGROUND OF THE INVENTION

### Technical Field

Exemplary embodiments of the present invention relate to a data processing estimating method for privacy protection and a system for performing the method. More particularly, exemplary embodiments of the present invention relate to a data processing estimating method for privacy protection using a statistical estimation block design and a system for performing the method.

### Discussion of the Related Art

With the advent of the big data era, various data of many people are being collected through various services. The collected data is being used in various machine learning technologies including artificial intelligence. However, among the data collected, there are many data that include sensitive personal information such as personal photos, purchase records, and locations. Therefore, the problem of privacy infringement on data providers is emerging as a social problem.

Cases of using inappropriate privacy data of various domestic and foreign big data companies are becoming a hot topic every day. Furthermore, there are cases in which the privacy of the data provider is unintentionally leaked by a service using the collected data.

In the process of collecting and using data, there is a need for a technology to protect the privacy of data providers. In particular, it is insufficient to process and use the collected data after collecting the original data. Accordingly, the necessity of a method of processing and providing the collected data so that it is difficult for the data provider to infer the original data before providing the data is highlighted.

### SUMMARY

Exemplary embodiments of the present invention provide a data processing estimating method for privacy protection using a statistical estimation block design that may increase statistical accuracy and communication efficiency while satisfying a goal of privacy protection.

Exemplary embodiments of the present invention provide a system for performing the above-mentioned data processing estimating method for privacy protection.

According to one aspect of the present invention, there is provided a data processing estimating method for privacy protection. In the method, a statistical estimation block design shared between data providers and data users is designed. Then, modification data is generated in a random manner along a conditional distribution for an original data of the statistical estimation block design. Then, a distribution of the original data is estimated using an estimation function based on the statistical estimation block design.

In an exemplary embodiment of the present invention, the modification data may be transmitted to the data user device.

In an exemplary embodiment of the present invention, the statistical estimation block design may include a (v, b, r, k, λ)-block design defined as a set ( [symbol] , [symbol] , [symbol] ) of two finite sets [symbol] , [symbol] and ordered pairs of elements [symbol] ␣ [symbol] × [symbol] of the two finite sets [symbol] , [symbol] . Here, the statistical estimation block design satisfies: condition 1 that | [symbol] |=v and | [symbol] |=b, condition 2 that the number of y∈ [symbol] being (x,y) ∈ [symbol] is r for each x∈ [symbol] , condition 3 that the number of x∈ [symbol] being (x, y) ∈ [symbol] is k for each y∈ [symbol] , and condition 4 that the number of y∈ [symbol] being (x, y), (x′, y)∈ [symbol] is λ for each different x, x′ ∈ [symbol] .

In an exemplary embodiment of the present invention, the statistical estimation block design may include a lookup-table that stores the modification data which is an output value, as true (O) or false (X) corresponding to the original data which is an input value.

In an exemplary embodiment of the present invention, the lookup table may satisfy the symmetry.

In an exemplary embodiment of the present invention, the statistical estimation block design may be an (\tilde{v}, b, r, k, λ)-block design. Here, v is the number of elements, b is the size of the modification data value set of the lookup-table, r is the number of truths (O) in one row of the lookup-table, k is the number of truths (O) in one column of the lookup-table, and λ is the number of overlapping truths (O) in any two rows of the lookup-table.

In an exemplary embodiment of the present invention, the generating the modification data may include (a-1) extracting a row corresponding to the original data from the lookup-table; (a-2) generating a random bit having a probability of 1 and a probability of 0; (a-3) randomly extracting one of the modification data values showing true (O) from the row extracted in step (a-1) when the random bit generated in step (a-2) is read 1; (a-4) randomly extracting one of the modification data values with false (X) from the row extracted in step (a-1) when the random bit generated in step (a-2) is read as 0; and (a-5) transmitting the modification data extracted in steps (a-3) and (a-4) to the data user.

In an exemplary embodiment of the present invention, the probability of 1 may be defined by the formula of

$$\frac{{re}^{ϵ}}{{re}^{ϵ} + b - r} ,$$

and the probability of 0 may be defined by the formula of

$$\frac{b - r}{{re}^{ϵ} + b - r} .$$

In an exemplary embodiment of the present invention, the estimating the statistics may include (b-1) receiving the modification data from data providers; (b-2) statistically processing the received variant data; (b-3) obtaining the number Nx of data having a high correlation with the original data value x for each original data value; and (b-4) obtaining an estimate value of the original data distribution based on the estimation function.

In an exemplary embodiment of the present invention, the estimation function may be defined by

$${\hat{P}}_{x} ( {Y}_{1} , ⋯ , {Y}_{n} ) = \frac{{re}^{ϵ} + b - r}{( r - λ ) ( {e}^{ϵ} - 1 )} \frac{{N}_{x} ( {Y}_{1} , ⋯ , {Y}_{n} )}{n} - \frac{λ {e}^{ϵ} + r - λ}{( r - λ ) ( {e}^{ϵ} - 1 )} .$$

Here, b is the size of the set of modification data values of the lookup-table, r is the number of truths (O) in one row of the lookup-table, λ is the number of overlapping truths (O) in any two rows of the lookup-table, and Nₓ(Y₁, . . . , Yₙ) is the number of data highly related to x in Y₁, . . . , Yₙ.

In an exemplary embodiment of the present invention, the Nₓ(Y₁, . . . , Yₙ) may be defined as Σᵢ₌₁ⁿI((x, Yₗ)∈ [symbol] ) (wherein I is the indication function).

According to another aspect of the present invention, a data processing estimating system for privacy protection includes a block design unit for designing block designs for statistical estimation shared between data providers and data users; a modification data generating unit for generating modification data in a random manner along a conditional distribution for the original data of the above statistical estimation block design; and a data distribution estimating unit for estimating the distribution of the original data using an estimation function based on the statistical estimation block design.

In an exemplary embodiment of the present invention, the statistical estimation block design may include a (v, r, k, λ)-block design defined as two finite sets [symbol] , [symbol] and a collection ( [symbol] , [symbol] , [symbol] ) of ordered pairs [symbol] ⊂ [symbol] × [symbol] of elements of [symbol] , [symbol] . Here, the statistical estimation block design satisfies: condition 1 where | [symbol] |=v and || [symbol] |=b, condition 2 in which the number of y∈ [symbol] . being (x, y)∈ [symbol] for each x∈ [symbol] is r, condition 3 in which the number ofx ∈ [symbol] being (x, y) ∈ [symbol] for each y∈ [symbol] is k, and condition 4 in which the number of y∈ [symbol] being (x, y)(x′, y)∈ [symbol] for each different x, x′ ∈ [symbol] is λ.

In an exemplary embodiment of the present invention, the statistical estimation block design may include a lookup-table that stores the modification data, which is an output value, as true (O) or false (X) corresponding to the original data which is an input value.

In an exemplary embodiment of the present invention, the statistical estimation block design may be an (v, b, r, k, λ)-block design. Here, v is the number of elements, b is the size of the modification data value set of the lookup-table, r is the number of truths (O) in one row of the lookup-table, k is the number of truths (O) in one column of the lookup-table, and A is the number of overlapping truths (O) in any two rows of the lookup-table.

In an exemplary embodiment of the present invention, the modification data generating unit may extract a row corresponding to the original data from the lookup-table, generate a random bit having a probability of 1 and a probability of 0, respectively, and randomly extract one of the modification data values showing true (O) from the extracted row when the generated random bit is read as 1. Moreover, the modification data generating unit may randomly extract one of the modification data values with false (X) from the extracted row when the generated random bit is read as 0, and transmit the extracted modification data to the data user.

In an exemplary embodiment of the present invention, the probability of 1 may be defined by the formula of

$$\frac{{re}^{ϵ}}{{re}^{ϵ} + b - r} ,$$

and the probability of 0 may be defined by the formula of

$$\frac{b - r}{{re}^{ϵ} + b - r} .$$

In an exemplary embodiment of the present invention, the data distribution estimating unit may receive the modification data from data providers, statistically process the received variant data, obtain the number Nx of data with a high correlation with the original data value x for each original data value, and obtain an estimate value of the original data distribution based on the estimation function.

In an exemplary embodiment of the present invention, the estimation function may be defined by

$${\hat{P}}_{x} ( {Y}_{1} , ⋯ , {Y}_{n} ) = \frac{{re}^{ϵ} + b - r}{( r - λ ) ( {e}^{ϵ} - 1 )} \frac{{N}_{x} ( {Y}_{1} , ⋯ , {Y}_{n} )}{n} - \frac{λ {e}^{ϵ} + r - λ}{( r - λ ) ( {e}^{ϵ} - 1 )} .$$

Here, b is the size of the set of modification data values of the lookup-table, r is the number of truths (O) in one row of the lookup-table, λ is the number of overlapping truths (O) in any two rows of the lookup-table, and Nₓ(Y₂, . . . , Yₙ) is the number of data highly related to x in Y₂, . . . , Yₙ.

In an exemplary embodiment of the present invention, the Nₓ(Y₁, . . . , Yₙ) may be defined as Σᵢ₌₁ⁿ((x, Yᵢ)∈ [symbol] ) (wherein I is the indication function).

According to the data processing estimating method for privacy protection and the system for performing the same, data processing techniques and estimation functions are provided by utilizing statistical estimation block designs shared between data providers and data users, thereby preventing leakages of sensitive personal information such as personal photos, purchase records, and locations included in the collected data, it is possible to increase statistical accuracy and communication efficiency while satisfying the goal of privacy protection by preventing leakage of sensitive personal information.

### BRIEF DESCRIPTION OF THE DRAWINGS

The above and other features and aspects of the present invention will become more apparent by describing in detailed exemplary embodiments thereof with reference to the accompanying drawings, in which:

FIG. 1 is a schematic diagram for schematically explaining a data processing and estimation model according to the present invention;

FIG. 2 is a block diagram schematically explaining a data processing estimating system for privacy protection according to an embodiment of the present invention;

FIG. 3 is a flowchart explaining a method of processing estimating data for privacy protection according to an embodiment of the present invention;

FIG. 4 is a flowchart explaining a step of generating modification data described in FIG. 3;

FIG. 5 is a flowchart explaining a step of estimating distribution of original data described in FIG. 3; and

FIG. 6 is a diagram for intuitively explaining distribution estimation of original data described in FIG. 5.

### DETAILED DESCRIPTION OF THE INVENTION

The present invention is described more fully hereinafter with reference to the accompanying drawings, in which exemplary embodiments of the present invention are shown. The present invention may, however, be embodied in many different forms and should not be construed as limited to the exemplary embodiments set forth herein. Rather, these exemplary embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the invention are described herein with reference to cross-sectional illustrations that are schematic illustrations of idealized exemplary embodiments (and intermediate structures) of the present invention. As such, variations from the shapes of the illustrations as a result, for example, of manufacturing techniques and/or tolerances, are to be expected. Thus, exemplary embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

In order to theoretically ensure that a modification data prevents leakage of privacy, an index that may mathematically quantify how much each data processing technique leaks privacy is needed.

The data processing technique can theoretically be expressed as a conditional distribution Q(y|x) of the modification data y according to the original data x. There are several indicators of privacy leakage. In the present invention, local differential privacy (“LDP”), which is an index used in academia and businesses, will be used, which is defined as follows:

### [Definition 1]

When the data processing technique Q satisfies the following formula for a certain ∈>0, the technique may be defined as an ‘∈-LDP technique’.

Q(y|x)≤e^{∈}Q(y|x′),∀x,x′,y.

Conceptually, some techniques are ‘∈-LDP techniques” means that an amount of privacy data of X included by Y is up to ∈ or less, when Y is output by applying a processing technique to an original data X. Here, it has been demonstrated that the amount of privacy data may be expressed as a logarithmic increase in a success probability of finding out privacy data of X by mathematically approaching Y.

There are two major tasks in a design of data processing techniques that satisfy privacy protection.

As the first task, since data users use modification data rather than original data, statistical estimation accuracy for data is reduced compared to using original data as it is. The theoretical basis of all machine learning technologies lies in statistical estimation, and the decrease in statistical estimation accuracy leads to a decrease in the quality of actual services. For example, an artificial intelligence search system may inform inaccurate information that is different from the facts, and a recommendation system may recommend content that is not related to or does not match the user's interests. Accordingly, data processing and statistical estimation techniques are needed to improve statistical estimation accuracy as much as possible while limiting the amount of privacy leakage to less than a specific value. Theoretically, the upper limit of statistical estimation accuracy for techniques with a privacy leakage of e-LDP or less has been identified, and a subset selection technique is known as a data processing and statistical estimation technique that achieves the upper limit.

As the second task, there is a problem that the size of the modification data may increase compared to the original data for privacy protection. In the case of the subset selection technique, which is the above example, the theoretical statistical estimation accuracy is optimal, but there is a problem that the size of the modification data increases exponentially with respect to the original data size. In order to transmit the modification data to the data user with this technique, enormous communication loads are generated.

Therefore, it is also an important task to improve the communication efficiency between the data provider and the data user by reducing the size of the modification data along with the accuracy of statistical estimation. A typical privacy protection data processing technique that improves known communication efficiency is Hadamard Response. However, except for certain circumstances, there is a problem that the accuracy of statistical estimation is greatly reduced according to the number of values that the original data can have and the limitation of the required privacy leakage.

The privacy protection data collection and statistical estimation system using a block design according to the present invention is characterized in that it provides a data processing technique and an estimation function using a concept of the block design in a statistical estimation system requiring privacy protection. Through the present invention, a method of greatly improving communication efficiency while making an accuracy of statistical estimation a known theoretical maximum value or a value close thereto is proposed.

The block design used in the present invention is a concept representing a relationship between original data satisfying a specific symmetry and modification data, and the block design is mathematically defined as the following definition 2.

### [Definition 2]

A tuple ( [symbol] , [symbol] , [symbol] ) of two finite sets [symbol] , [symbol] that satisfy the following conditions and a set [symbol] ⊂ [symbol] × [symbol] of ordered pairs of elements of [symbol] , [symbol] may be called a (v, b, r, k, λ)-block design.
(1) | [symbol] |=v and | [symbol] |=b.
(2) For each x∈ [symbol] , the number of y∈ [symbol] that become (x, y) ∈ [symbol] is r.
(3) For each y∈ [symbol] , the number of x∈ [symbol] that become (x, y) ∈ [symbol] is k.
(4) For each different x, x′ ∈ [symbol] , the number of y∈ [symbol] that become (x,y), (x′, y) ∈ [symbol] is λ.

The above (v, b, r, k, λ)-block design may be implemented in a form of a lookup-table that stores an output value, which is the modification data, as true (O) or false (x) in response to the original data, which is the input value, and the above definition 2 is explained again as follows.
(1) v is the number of elements, and b is the size of the modification data value set of the lookup-table.
(2) r is the number of truths (O) in one row of the lookup-table.
(3) k is the number of truths (O) in one column of the lookup-table.
(4) λ is the number of overlapping truths (O) in any two rows of the lookup-table.

A data processing estimating system for privacy protection to which the technology of the present invention is to be applied will be described in detail as follows.

A total of n data providers each have the original discrete data X∈ [symbol] , and each data provider converts the original discrete data X∈ [symbol] into data Y∈ [symbol] through the data processing technique Q and provides it to the data user. Subsequently, the data user estimates the distribution of the original data X after collecting Y data of each data provider.

At this time, it is assumed that the set [symbol] of values that each data provider's data X can have is a finite set with a fixed number of elements v, and the distribution of each X is independent for each data provider and comes from the same data distribution P. In addition, data users aim to design an estimation function \hat{P} that calculates an estimate value of the distribution of X from the collected Y and estimate the data distribution P accordingly. The original and variant data of the i-th data provider are represented by Xᵢ, Yᵢ, respectively, and the estimated function P is a function of Y₁, Y₂, . . . , Yₙ.

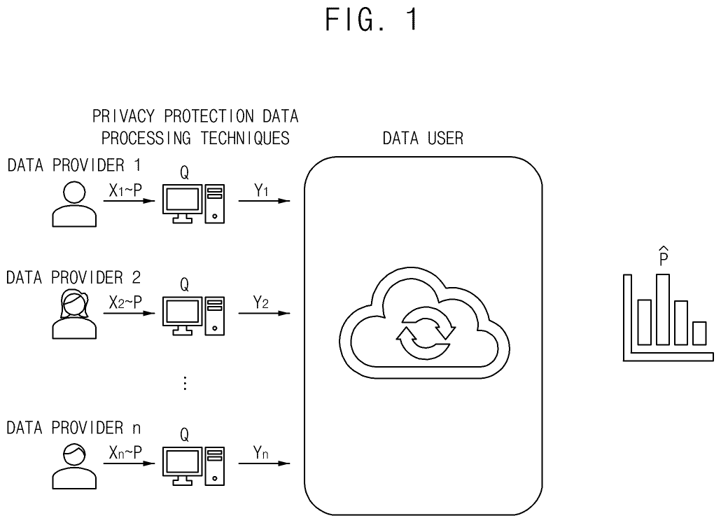

The overall schematic diagram of the data processing and estimation model described above is as shown in FIG. 1.

FIG. 1 is a schematic diagram for schematically explaining a data processing and estimation model according to the present invention.

Referring to FIG. 1, in a data processing estimating system for privacy protection, modification data is generated using a privacy protection data processing technique for the collected data of each data provider, and the generated modification data is provided to data users.

The challenge in the above system is to design a privacy protection data processing technique Q and an estimation function P that satisfies ‘e-LDP’ for a given set of original data values [symbol] and privacy leakage limit e.

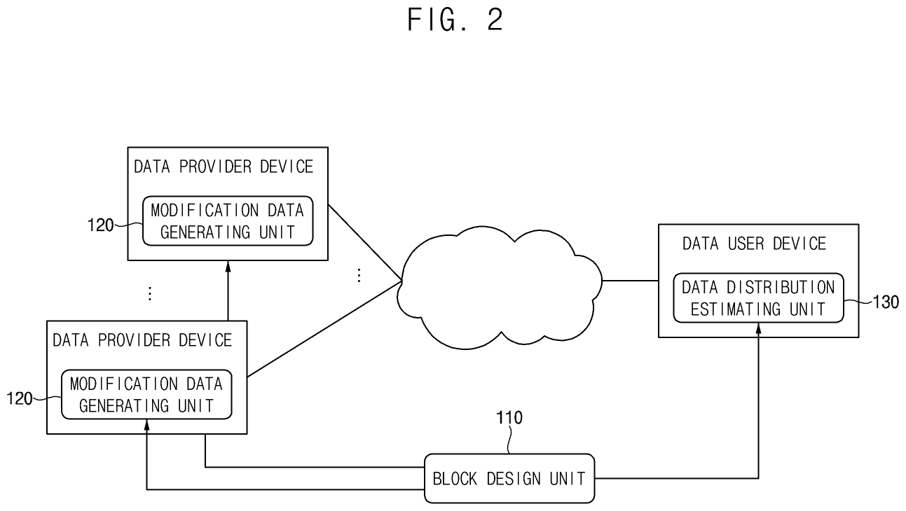

FIG. 2 is a block diagram schematically explaining a data processing estimating system for privacy protection according to an embodiment of the present invention.

Referring to FIG. 2, a data processing estimating system for privacy protection according to an embodiment of the present invention includes a block design unit 110, a modification data generating unit 120, and a data distribution estimating unit 130. The data processing estimating system for privacy protection is described as consisting of a block design unit 110, a modification data generating unit 120, and a data distribution estimating unit 130, but this is logically classified for convenience of explanation and is not hardware classified. In the present embodiment, the modification data generating unit 120 may be mounted on a data provider device (or a user computer), and the data distribution estimating unit 130 may be mounted on a data user device (or a central server). The block design unit 110 may be mounted on a data provider device, a data user device, a third electronic device, or the like. The data provider device and the data user device may be connected through various networks. In the present embodiment, the data provider device and the data provider may be used interchangeably, and the data user device and the data user may be used interchangeably.

The block design unit 110 designs a statistical estimation block design shared between a data provider and a data user. The block design unit 110 shares the designed statistical estimation block design between a data provider and a data user.

In this embodiment, the data user and all data providers know both the set [symbol] of the original data values, the number of elements v thereof, and the privacy leak limit ∈. In this situation, the following structure is designed and shared by the data user and all data providers.
Extended original data value set \tilde{X}⊂ [symbol] and its size \tilde{v}≥v
Variant Data Value Set [symbol] and Its Size b
(\tilde{v}, b, r, k, λ)-block design ( [symbol] , [symbol] , [symbol] )

In this case, for accuracy of statistical estimation, the block design used in the present exemplary embodiment satisfies the following conditions. The order in which the conditions have the greatest influence on accuracy is arranged.
Set the value of k close to v/(e^{∈}+1).
Set the value of \tilde{v} as small as possible and, if possible, \tilde{v}=v.

In addition, for communication efficiency, the following conditions are satisfied.
Set the value of b=| [symbol] | as small as possible.

The modification data generating unit 120 generates modification data in a randomized manner according to a conditional distribution for the original data of the block design for statistical estimation.

Each data provider i, for a given original data Xᵢ=x, generates transformed data Yᵢ in a random manner according to a conditional distribution Q(y|x) defined by the following Equation (1).

$$Q ( y \vert x ) = \{ \begin{matrix}\frac{{e}^{ϵ}}{r {e}^{ϵ} + b - r} & ( ( x , y ) ∈ 𝒥 ) \\ \frac{1}{r {e}^{ϵ} + b - r} & ( ( x , y ) ∉ 𝒥 )\end{matrix} \qquad [ Equation 1 ]$$

The data distribution estimating unit 130 estimates the distribution P of the original data using an estimation function based on the block design for statistical estimation above. It can be seen that estimating the distribution P of the original data is to estimate, for each possible original data value x, the average frequency or probability Pₓ=Pr(X=x) that that value is in the original data, and the design of the estimation function is to design a function \hat{P}ₓ(Y₁, Y₂, . . . , Yₙ) to estimate Pₓ for each x.

In the present invention, an estimation function as shown in the following Equation (2) is presented.

$$\hat{{P}_{x}} ( {Y}_{1} , … , {Y}_{n} ) = \frac{r {e}^{ϵ} + b - r}{( r - λ ) ( {e}^{ϵ} - 1 )} \frac{{N}_{x} ( {Y}_{1} , … , {Y}_{n} )}{n} - \frac{λ {e}^{ϵ} + r - λ}{( r - λ ) ( {e}^{ϵ} - 1 )} \qquad [ Equation 2 ]$$

Here, Nₓ(Y₁, . . . , Yₙ) is the number of data highly associated with x in Y₁, . . . , Yₙ, and may be defined as the following Equation (3).

$${N}_{x} ( {Y}_{1} , … , {Y}_{n} ) = {\sum }_{i = 1}^{n} I ( ( x , {Y}_{i} ) ∈ 𝒥 ) \qquad [ Equation 3 ]$$

Here, I is an indicator function.

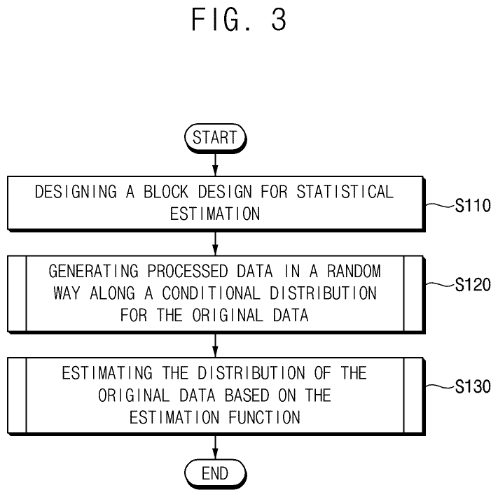

FIG. 3 is a flowchart explaining a method of processing estimating data for privacy protection according to an embodiment of the present invention.

Referring to FIG. 3, a block design for statistical estimation shared between a data provider and a data user is designed (step S110). Step S110 may be performed by the block design unit 110 described in FIG. 2.

Modification data is generated for the original data of the block design for statistical estimation in a random manner according to a conditional distribution (step S120). Step S120 may be performed by the modification data generating unit 120 described in FIG. 2.

The distribution of the original data is estimated using an estimation function based on the statistical estimation block design (step S130). Step S130 may be performed by the data distribution estimating unit 130 described with reference to FIG. 2.

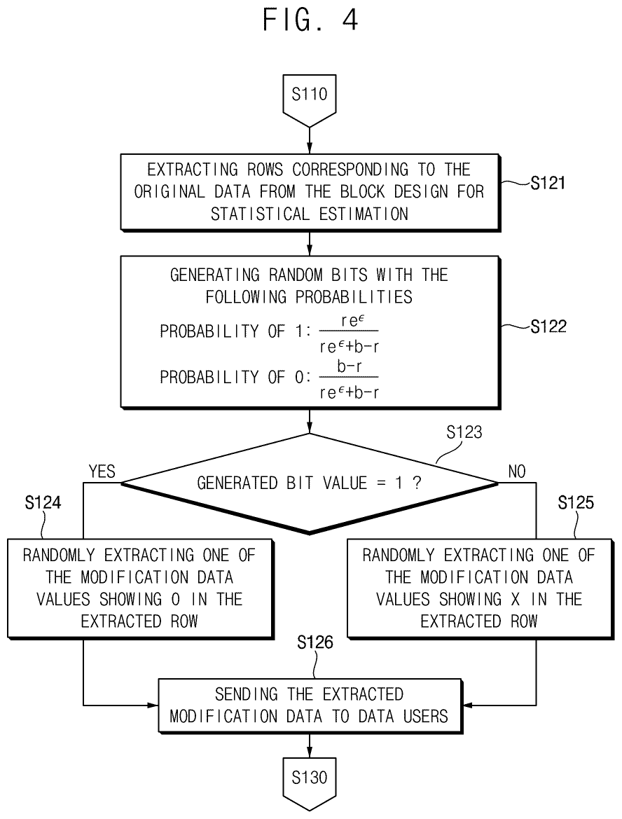

FIG. 4 is a flowchart explaining a step of generating modification data described in FIG. 3.

Referring to FIG. 3 and FIG. 4, a row corresponding to the original data is extracted from the lookup-table (step S121).

Then, a random bit having a probability of 1 defined by the formula of

$$\frac{r {e}^{ϵ}}{r {e}^{ϵ} + b - r}$$

and a probability of 0 defined by the formula of

$$\frac{b - r}{r {e}^{ϵ} + b - r}$$

is generated (step S122).

Then, it is checked that whether the generated bit value is 1 (step S123).

When the bit value generated in step S123 is checked as 1, one of the modification data values indicating O is randomly extracted from the extracted row (step S124).

When the bit value generated in step S123 is checked as 0, one of the modification data values represented by X is randomly extracted from the extracted row (step S125).

The modification data extracted in step S124 or step S125 is transmitted to the data user, that is, the data distribution estimating unit 130 (see FIG. 2) mounted on the data user device (step S126).

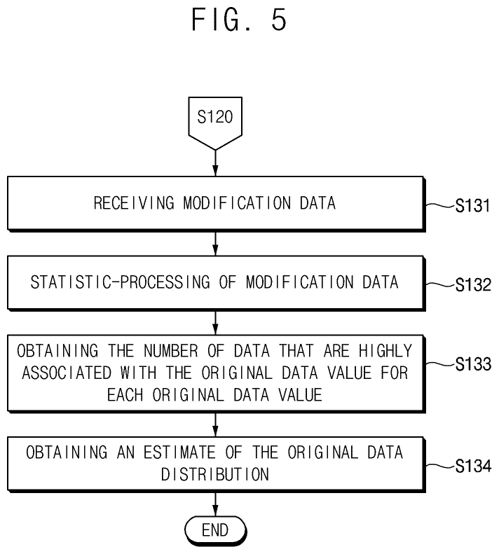

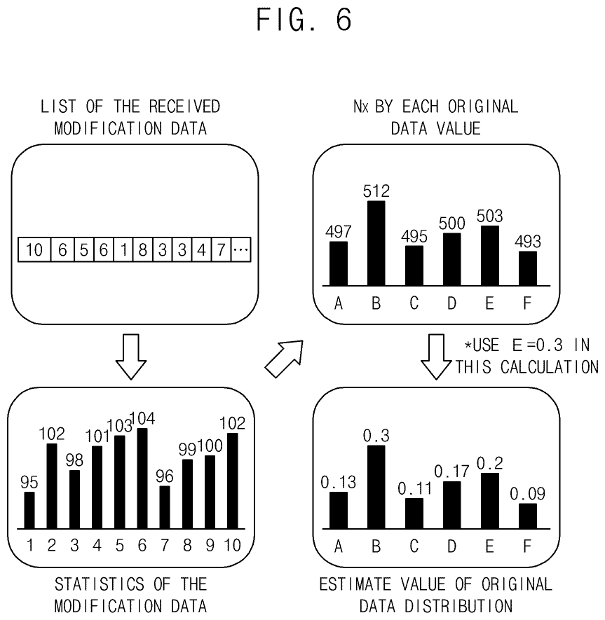

FIG. 5 is a flowchart explaining a step of estimating distribution of original data described in FIG. 3. FIG. 6 is a diagram for intuitively explaining distribution estimation of original data described in FIG. 5.

Referring to FIG. 3, FIG. 5, and FIG. 6, modification data is received (step S131). That is, as shown in FIG. 6, the modification data may be provided from the modification data generating unit 120 (see FIG. 2) mounted on the data provider device in the form of a data list as shown in [10, 6, 5, 6, 1, 8, 3, 3, 4, 7, . . . ].

Then, the received modification data is statistically processed (step S132). The statistical processing may be performed by the data distribution estimating unit 130 (see FIG. 2) mounted on the data user device. As shown in FIG. 6, when the modification data received from the provider is [10, 6, 5, 6, 1, 8, 3, 3, 4, 7, . . . ], the modification data is statistically processed to count the number of each number. That is, the number of 10, the number of 6, the number of 5, and the number of 1 are counted. In the present exemplary embodiment, an example of a lookup-table in which original data and modification data are mapped is shown in the following Table 1.

TABLE 1

| | Modification | | | | | | | | | |
|---|---|---|---|---|---|---|---|---|---|---|
| Original | Data Values | | | | | | | | | |
| Data values | 1 | 2 | 3 | 4 | 5 | 6 | 7 | 8 | 9 | 10 |
| A | ◯ | X | ◯ | ◯ | ◯ | X | X | X | ◯ | X |
| B | X | ◯ | X | ◯ | ◯ | ◯ | X | X | X | ◯ |
| C | ◯ | X | X | ◯ | X | ◯ | ◯ | ◯ | X | X |
| D | X | ◯ | X | X | ◯ | X | ◯ | ◯ | ◯ | X |
| E | X | X | ◯ | X | X | ◯ | X | ◯ | ◯ | ◯ |
| F | ◯ | ◯ | ◯ | X | X | X | ◯ | X | X | ◯ |

Subsequently, the number Nx of data having a high correlation with the original data value is obtained for each original data value (step S133). The above-described step S133 may be performed by the data distribution estimating unit 130 (see FIG. 2) mounted in the data user device.

That is, the number Nx of data having a high correlation with the original data value x of the lookup table is obtained. Specifically, the number of data having a high correlation with the original data A is obtained as NA(Y1, . . . , Yn)=497 (i.e., 95+98+101+103+100). In addition, the number of data having a high correlation with the original data B is obtained as NB(Y1, . . . , Yn)=512 (i.e., 102+101+103+104+104+102). In addition, the number of data having a high correlation with the original data C is obtained as NC(Y1, . . . , Yn)=495 (i.e., 95+101+104+96+99). In addition, the number of data having a high correlation with the original data D is obtained as ND(Y1, . . . , Yn)=500 (i.e., 102+103+96+99+100). In addition, the number of data having a high correlation with the original data F is obtained as NF(Y1, . . . , Yn)=493 (i.e., 95+102+98+96+102).

Subsequently, an estimated value of the original data distribution is obtained (step S134). The step S134 may be performed by the data distribution estimating unit 130 (see FIG. 2) mounted on the data user device. Specifically, estimates of the data distribution of each of the original data A, B, C, D, E, and F are calculated using the Equation (2). In the lookup-table shown in Table 1, it may be seen that b is 10, r is 5, and λ is 2.

The data processing estimating system for privacy protection according to the present invention described above may evaluate a measurement index of statistical estimation accuracy and a measurement index of communication efficiency.

That is, the measurement index of statistical estimation accuracy may express the maximum mean square error between the distribution of the original data and the estimate by the following Equation (4). The smaller the maximum mean square error, the higher the common estimation accuracy.

$${sup}_{P} {\sum }_{x ∈ X} {\vert {P}_{x} - \hat{{P}_{x}} \vert}^{2} \qquad [ Equation 4 ]$$

Meanwhile, the number of bits used for communication per data provider may be used as a measurement index of communication efficiency. The smaller the number of bits, the higher the communication efficiency.

The data processing technique presented in the present invention satisfies the E-LDP constraint, and a performance index thereof is as follows.

[Theorem 1] The maximum mean square error of the technique proposed in the present invention designed using the (\tilde{v}, b, r, k, λ)-block design is as follows.
(1) For

$$\tilde{v} = v , \frac{{( v - 1 )}^{2} {( k {e}^{ϵ} + v - k )}^{2}}{k ( v - k ) {( {e}^{ϵ} - 1 )}^{2} n v}$$

(2) For general cases,

$$\frac{( r {e}^{ϵ} + ( v - 1 ) ( λ {e}^{ϵ} + r - λ ) ) ( v ( b - r ) + ( v - 1 ) ( r - λ ) ( {e}^{ϵ} - 1 ) )}{{( r - λ )}^{2} {( {e}^{ϵ} - 1 )}^{2} n v}$$

Also, the number of communication bits per data provider is log ₂ b.

At this time, comparing the statistical estimation accuracy of this invention with the optimal estimation accuracy determined, it may be confirmed that this technique achieves the optimal estimation accuracy when a block design that satisfies \tilde{v}=v and k=k* (here, k* is one of the two integers close to

$$\frac{v}{{e}^{ϵ} + 1} )$$

is used.

[Theorem 2]\tilde{v}=v and designed using a (\tilde{v}, b, r, k, λ)-block design satisfying k=k*, the technique proposed by the present invention achieves optimal statistical estimation accuracy.

Comparing a technique proposed by the present invention with a conventional technique is as follows.

First, a comparison of the technique proposed by the present invention with the previously known subset selection technique, which has been shown to be optimal in terms of statistical estimation accuracy, is as follows.

In terms of statistical estimation accuracy, optimal accuracy can be achieved using a block design that satisfies the conditions of Theorem 2, as with Subset Selection. Even if the conditions of Theorem 2 are not fully satisfied, as long as the block design used satisfies \tilde{v}≈v and k≈k*, it is possible to achieve accuracy close to optimal accuracy.

For the communication efficiency of Subset Selection, there is a problem that the number of communication bits per data provider can be very large depending on the value of k*. On the other hand, for the communication efficiency of the technique proposed in the present invention, there are many well-known block designs with very small values of b, which can be utilized to achieve very high communication efficiency.

Next, a comparison of existing techniques that have shown improvements in communication efficiency with the techniques proposed by the present invention is shown below.

Previously known techniques with improved communication efficiency include the Hadamard Response (“HR”) and Projective Geometry Response (“PGR”) described above. However, these techniques have high statistical inference accuracy and communication efficiency only for a very specific privacy leakage bound E and a certain number v of the original data.

In contrast, the technique proposed herein utilizes many well-known block designs, as described above, and has higher statistical inference accuracy and communication efficiency for a wider variety of (∈, v) than existing techniques.

Improvements in statistical inference accuracy and communication efficiency over specific existing techniques are illustrated by the following embodiments.

The performance comparison of the method proposed in the present invention and the previously known method was carried out by simulation in the following practical situations, and the performance advantage of the method proposed in the present invention can be confirmed.

Experimental Environment and Experimental Process (estimation of statistics on product preference)

(1) We would like to estimate the statistics of 1,000 consumers' product preferences for 19 products (i.e., Product 1, Product 2, . . . , Product 19).

(2) As a data provider, each consumer i ∈[1:1000] has his or her favorite product number xᵢ∈ [symbol] =[1:19] as the original data, and each consumer's original data is created to be independent and equally distributed.

(3) Each consumer requires 0.1-LDP as a privacy leakage amount limit, and accordingly, each consumer generates the transformed data yᵢ using a privacy-preserving data processing technique that satisfies 0.1-LDP on the original data.

(4) As a data utilizer, the statistical estimation entity collects the variant data y₁, y₂, . . . , y₁₀₀₀ of the consumers and calculates an estimate value of the original data distribution via the statistical estimation function \hat{P}.

(5) Calculate the squared error between the estimated distribution and the uniform distribution, which is the distribution of the original data.

(6) Perform the above process 100,000 times for each of the three techniques, the technique proposed in the present invention, Subset Selection, and Hadamard Response, and calculate the average of the squared error for each technique.

(7) Compare the theoretical maximum mean square error, the number of communicated bits per person, and the average of 100,000 experimentally obtained square errors.

When using the technique proposed in the present exemplary embodiment, the block design will use Paley's Hadamard matrix-based (19,19,9,9,4)-block design. Examples of the above (19,19,9,9,9)-block design are shown in the following Table 2.

TABLE 2

| | Modification | | | | | | | | | | | | | | | | | | |
|---|---|---|---|---|---|---|---|---|---|---|---|---|---|---|---|---|---|---|---|
| Original | Data Values | | | | | | | | | | | | | | | | | | |
| data values | 1 | 2 | 3 | 4 | 5 | 6 | 7 | 8 | 9 | 10 | 11 | 12 | 13 | 14 | 15 | 16 | 17 | 18 | 19 |
| Product 1 | X | ◯ | X | X | ◯ | ◯ | ◯ | ◯ | X | ◯ | X | ◯ | X | X | X | X | ◯ | ◯ | X |
| Product 2 | X | X | ◯ | X | X | ◯ | ◯ | ◯ | ◯ | X | ◯ | X | ◯ | X | X | X | X | ◯ | ◯ |
| Product 3 | ◯ | X | X | ◯ | X | X | ◯ | ◯ | ◯ | ◯ | X | ◯ | X | ◯ | X | X | X | X | ◯ |
| Product 4 | ◯ | ◯ | X | X | ◯ | X | X | ◯ | ◯ | ◯ | ◯ | X | ◯ | X | ◯ | X | X | X | X |
| Product 5 | X | ◯ | ◯ | X | X | ◯ | X | X | ◯ | ◯ | ◯ | ◯ | X | ◯ | X | ◯ | X | X | X |
| Product 6 | X | X | ◯ | ◯ | X | X | ◯ | X | X | ◯ | ◯ | ◯ | ◯ | X | ◯ | X | ◯ | X | X |
| Product 7 | X | X | X | ◯ | ◯ | X | X | ◯ | X | X | ◯ | ◯ | ◯ | ◯ | X | ◯ | X | ◯ | X |
| Product 8 | X | X | X | X | ◯ | ◯ | X | X | ◯ | X | X | ◯ | ◯ | ◯ | ◯ | X | ◯ | X | ◯ |
| Product 9 | ◯ | X | X | X | X | ◯ | ◯ | X | X | ◯ | X | X | ◯ | ◯ | ◯ | ◯ | X | ◯ | X |
| Product 10 | X | ◯ | X | X | X | X | ◯ | ◯ | X | X | ◯ | X | X | ◯ | ◯ | ◯ | ◯ | X | ◯ |
| Product 11 | ◯ | X | ◯ | X | X | X | X | ◯ | ◯ | X | X | ◯ | X | X | ◯ | ◯ | ◯ | ◯ | X |
| Product 12 | X | ◯ | X | ◯ | X | X | X | X | ◯ | ◯ | X | X | ◯ | X | X | ◯ | ◯ | ◯ | ◯ |
| Product 13 | ◯ | X | ◯ | X | ◯ | X | X | X | X | ◯ | ◯ | X | X | ◯ | X | X | ◯ | ◯ | ◯ |
| Product 14 | ◯ | ◯ | X | ◯ | X | ◯ | X | X | X | X | ◯ | ◯ | X | X | ◯ | X | X | ◯ | ◯ |
| Product 15 | ◯ | ◯ | ◯ | X | ◯ | X | ◯ | X | X | X | X | ◯ | ◯ | X | X | ◯ | X | X | ◯ |
| Product 16 | ◯ | ◯ | ◯ | ◯ | X | ◯ | X | ◯ | X | X | X | X | ◯ | ◯ | X | X | ◯ | X | X |
| Product 17 | X | ◯ | ◯ | ◯ | ◯ | X | ◯ | X | ◯ | X | X | X | X | ◯ | ◯ | X | X | ◯ | X |
| Product 18 | X | X | ◯ | ◯ | ◯ | ◯ | X | ◯ | X | ◯ | X | X | X | X | ◯ | ◯ | X | X | ◯ |
| Product 19 | ◯ | X | X | ◯ | ◯ | ◯ | ◯ | X | ◯ | X | ◯ | X | X | X | X | ◯ | ◯ | X | X |

Referring to Table 2, (19,19,9,9,9)-block design, the number of elements is 19, and the size of the modification data set in one row is 19. Moreover, the number of true (O) in one row is 9, and the number of true (O) in one column is 9. Moreover, when looking at any different rows, the number of true ( ) in both rows is 4.

The results of the experiment conducted in the above-described manner are shown in the following Table 3. The smaller the number in all the result values, the better.

TABLE 3

| | | Traditional | Traditional |
|---|---|---|---|
| | The techniques | Techniques: | Techniques: |
| | of the present | Subset | Hadamard |
| | invention | Selection | Response |
| Theoretical value | 6.815 | 6.815 | 7.612 |
| of maximum mean | | | |
| square error | | | |
| Square error | 6.813 | 6.809 | 7.627 |
| Average 100,000 | | | |
| experimental values | | | |
| Number of | 4.25 | 16.50 | 5.00 |
| communication | | | |
| bits per person | | | |

As described above, according to the present invention, data processing techniques and estimation functions are provided by utilizing statistical estimation block designs shared between data providers and data users, thereby preventing leakages of sensitive personal information such as personal photos, purchase records, and locations included in the collected data, it is possible to increase statistical accuracy and communication efficiency while satisfying the goal of privacy protection by preventing leakage of sensitive personal information.

Meanwhile, terms “\tilde{ }er/or” or “module” used in the disclosure may include units configured by hardware, software, or firmware, and may be used compatibly with terms such as, for example, logics, logic blocks, components, circuits, or the like. The term “\tilde{ }er/or” or “module” may be an integrally configured component or a minimum unit performing one or more functions or a part thereof. For example, the module may be configured by an application-specific integrated circuit (ASIC).

The diverse embodiments of the disclosure may be implemented by software including instructions stored in a machine-readable storage medium (for example, a computer-readable storage medium). A machine may be a device that invokes the stored instruction from the storage medium and may be operated depending on the invoked instruction, and may include the electronic device according to the disclosed embodiments. In a case where a command is executed by the processor, the processor may directly perform a function corresponding to the command or other components may perform the function corresponding to the command under a control of the processor. The command may include codes created or executed by a compiler or an interpreter. The machine-readable storage medium may be provided in a form of a non-transitory storage medium. Here, the term ‘non-transitory’ means that the storage medium is tangible without including a signal, and does not distinguish whether data are semi-permanently or temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., “\tilde{ }er/or” or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

The foregoing is illustrative of the present invention and is not to be construed as limiting thereof. Although a few exemplary embodiments of the present invention have been described, those skilled in the art will readily appreciate that many modifications are possible in the exemplary embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific exemplary embodiments disclosed, and that modifications to the disclosed exemplary embodiments, as well as other exemplary embodiments, are intended to be included within the scope of the appended claims. The present invention is defined by the following claims, with equivalents of the claims to be included therein.

The invention claimed is:

1. A data processing estimating method for privacy protection, the method comprising:
designing a statistical estimation block design shared between data providers and data users;
generating modification data in a random manner along a conditional distribution for an original data of the statistical estimation block design; and
estimating a distribution of the original data using an estimation function based on the statistical estimation block design.

2. The method of claim 1, wherein the modification data is transmitted to the data user device.

3. The method of claim 1, wherein the statistical estimation block design comprises a (v, b, r, k, λ)-block design defined as a set ( [symbol] , [symbol] , [symbol] ) of two finite sets [symbol] , [symbol] and ordered pairs of elements [symbol] ⊂ [symbol] × [symbol] of the two finite sets [symbol] , [symbol] , and
wherein the statistical estimation block design satisfies:
condition 1 that | [symbol] |=v and | [symbol] |=b,
condition 2 that the number of y∈ [symbol] being (x, y) ∈ [symbol] is r for each x∈ [symbol] ,
condition 3 that the number of x∈ [symbol] being (x, y) ∈ [symbol] is k for each y∈ [symbol] , and
condition 4 that the number of y∈ [symbol] being (x, y), (x′, y) ∈ [symbol] is λ for each different x, x′ ∈ [symbol] .

4. The method of claim 1, wherein the statistical estimation block design comprises a lookup-table that stores the modification data which is an output value, as true (O) or false (X) corresponding to the original data which is an input value.

5. The method of claim 4, wherein the lookup table satisfies the symmetry.

6. The method of claim 4, wherein the statistical estimation block design is an (\tilde{v}, b, r, k, λ)-block design,
wherein v is the number of elements, b is the size of the modification data value set of the lookup-table, r is the number of truths (O) in one row of the lookup-table, k is the number of truths (O) in one column of the lookup-table, and A is the number of overlapping truths (O) in any two rows of the lookup-table.

7. The method of claim 4, wherein the generating the modification data comprises:
(a-1) extracting a row corresponding to the original data from the lookup-table;
(a-2) generating a random bit having a probability of 1 and a probability of 0;
(a-3) randomly extracting one of the modification data values showing true (O) from the row extracted in step (a-1) when the random bit generated in step (a-2) is read 1;
(a-4) randomly extracting one of the modification data values with false (X) from the row extracted in step (a-1) when the random bit generated in step (a-2) is read as 0; and
(a-5) transmitting the modification data extracted in steps (a-3) and (a-4) to the data user.

8. The method of claim 7, wherein the probability of 1 is defined by the formula of
$$\frac{r {e}^{ϵ}}{r {e}^{ϵ} + b - r} ,$$
and the probability of 0 is defined by the formula of
$$\frac{b - r}{r {e}^{ϵ} + b - r} .$$

9. The method of claim 1, wherein the estimating the statistics comprises:
(b-1) receiving the modification data from data providers;
(b-2) statistically processing the received variant data;
(b-3) obtaining the number Nx of data having a high correlation with the original data value x for each original data value; and
(b-4) obtaining an estimate value of the original data distribution based on the estimation function.

10. The method of claim 1, wherein the estimation function is defined by
$$\hat{{P}_{x}} ( {Y}_{1} , … , {Y}_{n} ) = \frac{r {e}^{ϵ} + b - r}{( r - λ ) ( {e}^{ϵ} - 1 )} \frac{{N}_{x} ( {Y}_{1} , … , {Y}_{n} )}{n} - \frac{λ {e}^{ϵ} + r - λ}{( r - λ ) ( {e}^{ϵ} - 1 )} ,$$
where b is the size of the set of modification data values of the lookup-table, r is the number of truths (O) in one row of the lookup-table, λ is the number of overlapping truths (O) in any two rows of the lookup-table, and Nₓ(Y₁, . . . , Yₙ) is the number of data highly related to x in Y₁, . . . Yₙ.

11. The method of claim 10, wherein the Nₓ(Y₁, . . . , Yₙ) is defined as Σᵢ₌₁ⁿI((x, Y₁)∈( [symbol] ) (wherein I is the indication function).

12. A data processing estimating system for privacy protection, the system comprising:
a block design unit for designing block designs for statistical estimation shared between data providers and data users;
a modification data generating unit for generating modification data in a random manner along a conditional distribution for the original data of the above statistical estimation block design; and
a data distribution estimating unit for estimating the distribution of the original data using an estimation function based on the statistical estimation block design.

13. The system of claim 12, wherein the statistical estimation block design comprises a (v, b, r, k, λ)-block design defined as two finite sets [symbol] , [symbol] and a collection ( [symbol] , [symbol] , [symbol] ) of ordered pairs [symbol] ⊂ [symbol] × [symbol] of elements of [symbol] , [symbol] ,
wherein the statistical estimation block design satisfies:
condition 1 where | [symbol] |=v and || [symbol] |=b,
condition 2 in which the number of y∈ [symbol] , being (x, y) ∈ [symbol] for each x∈ [symbol] is r,
condition 3 in which the number of x∈ [symbol] being (x,y) ∈ [symbol] for each y∈ [symbol] is k, and
condition 4 in which the number of y∈ [symbol] being (x, y), (x′, y)∈ [symbol] for each different x, x′∈ [symbol] is λ.

14. The system of claim 12, wherein the statistical estimation block design comprises a lookup-table that stores the modification data which is an output value, as true (O) or false (X) corresponding to the original data which is an input value.

15. The system of claim 14, wherein the statistical estimation block design is an (\tilde{v}, b, r, k, λ)-block design,
wherein v is the number of elements, b is the size of the modification data value set of the lookup-table, r is the number of truths (O) in one row of the lookup-table, k is the number of truths (O) in one column of the lookup-table, and A is the number of overlapping truths (O) in any two rows of the lookup-table.

16. The system of claim 14, wherein the modification data generating unit extracts a row corresponding to the original data from the lookup-table,
generates a random bit having a probability of 1 and a probability of 0, respectively, randomly extracts one of the modification data values showing true (O) from the extracted row when the generated random bit is read as 1,
randomly extracts one of the modification data values with false (X) from the extracted row when the generated random bit is read as 0, and
transmits the extracted modification data to the data user.

17. The system of claim 16, wherein the probability of 1 is defined by the formula of
$$\frac{r {e}^{ϵ}}{r {e}^{ϵ} + b - r} ,$$
and the probability of 0 is defined by the formula of
$$\frac{b - r}{r {e}^{ϵ} + b - r} .$$

18. The system of claim 12, wherein the data distribution estimating unit receives the modification data from data providers,
statistically processes the received variant data,
obtains the number Nx of data with a high correlation with the original data value x for each original data value, and
obtains an estimate value of the original data distribution based on the estimation function.

19. The system of claim 12, wherein the estimation function is defined by
$$\hat{{P}_{x}} ( {Y}_{1} , … , {Y}_{n} ) = \frac{r {e}^{ϵ} + b - r}{( r - λ ) ( {e}^{ϵ} - 1 )} \frac{{N}_{x} ( {Y}_{1} , … , {Y}_{n} )}{n} - \frac{λ {e}^{ϵ} + r - λ}{( r - λ ) ( {e}^{ϵ} - 1 )} ,$$
where b is the size of the set of modification data values of the lookup-table, r is the number of truths (O) in one row of the lookup-table, λ is the number of overlapping truths (O) in any two rows of the lookup-table, and Nₓ(Y₁, . . . , Yₙ) is the number of data highly related to x in Y₁, . . . , Yₙ.

20. The system of claim 19, wherein the Nₓ(Y₁, . . . , Yₙ) is defined as Σᵢ₌₁I(x, Yᵢ)∈ [symbol] ), wherein I is the indication function.
